(19) United States
(12) Patent Application Publication
(10) Pub. No.: US 2004/0210846 A1
(43) Pub. Date: Oct. 21, 2004

(54) Transparent network clipboard sharing

(76) Inventor: Gregory P. Olsen, Lindon, UT (US)

Correspondence Address: TRASK BRITT, P.O. BOX 2550, SALT LAKE CITY, UT, 84110, US

(21) Appl. No.: 10/828,783

(22) Filed: Apr. 21, 2004

Related U.S. Application Data
(60) Provisional application No. 60/464,374, filed on Apr. 21, 2003.

(51) Int. Cl. G09G 5/00; G06F 15/167

(52) U.S. Cl. 715/761; 709/212; 345/751

(57) ABSTRACT

A method for transferring clipboard data from computer to computer includes recognizing that a change has been made to the clipboard of a first computer of a predefined network and notifying at least one second computer of the network that the clipboard data on the first computer has been changed. Each second computer may then send a request to the first computer to paste the data that has been copied to the clipboard of the first computer to a file in an application running on the second computer.

### CROSS-REFERENCE TO RELATED APPLICATION

Under the provisions of 35 U.S.C. § 119(e), a claim is made for the benefit of priority to the filing date of U.S. Provisional Patent Application Serial No. 60/464,374, filed Apr. 21, 2003, for “Transparent Network Clipboard Sharing,” pending.

### BACKGROUND OF RELATED ART

1. Field of the Invention

The present invention relates generally to methods and programs for effecting sharing of clipboard data between networked computers, as well as to computer networks on which clipboard data may be freely shared. More specifically, the present invention relates to methods and programs for sharing clipboard data between different networked computers without requiring any commands in addition to those that would be ordinarily required to “copy” or “cut,” then “paste” data on a single computer.

2. Background of Related Art

The operating systems (OSs) of computers are typically configured with clipboards, which permit a user to “copy” data thereto in one or more formats, then “paste” the data elsewhere. Such “copying” and “pasting” may be effected in a single application, or program, or across multiple applications. Conventionally, once data was “copied” to a clipboard, the data that previously resided, or was stored, on the clipboard was removed therefrom.

As computers are networked with other computers, both locally and remotely, with ever-increasing frequency, the desirability for sharing data that has been “copied” to a clipboard on one computer with an application on another computer is likewise increasing.

Some programs have been developed to facilitate such data sharing between different computers, even between different platforms (e.g., Linux®, Windows®, etc.) A few of these programs are listed below:

The Network Clipboard—(http://netclipboard.sourceforge.net);

Clipboard Genie—(http://www.vsisystems.com/clipboard.htm);

Network Clipboard—(http://www.globware.com/softwareview.asp?Ware=14); and

Network Clipboard—(http://www.overberg.org/netclip).

Nonetheless, each of these programs, as well as other, similar programs, suffer from a variety of undesirable features. For example, many clipboard data-sharing programs do not support all clipboard data formats. In fact, many clipboard data-sharing programs are limited to sharing only text. The inventor is not aware of any existing clipboard data-sharing program that supports sharing of registered clipboard formats that are specific to a particular application.

Moreover, a user who would like to share the clipboard data on one computer with an application on another computer may be required to perform one or more tasks so that such clipboard data may be shared. For example, a user may be required to effect some sort of targeting user interface (UI) to select or identify the source computer. The user may also be required to identify a particular item of data that is to be shared from a remote clipboard collection. Other clipboard data-sharing programs require the user to identify both the computer from which data will be copied and the computer with which the data will be shared, then command the data-sharing computer to transfer the data to the data-receiving computer.

Accordingly, there are needs for a method and program by which data may be copied to the clipboard of a first computer and accessed and pasted by a second computer without requiring the user to do anything more than issue a “copy” or “cut” command on the first computer and a “paste” command on the second computer.

### SUMMARY OF THE INVENTION

The present invention includes a method that allows multiple, networked computers to automatically share clipboard data, as well as a program for effecting the method and computer networks that share clipboard data.

When data from a software application which is being executed, or “running,” on a computer is “copied,” it places the data on the computer's “clipboard,” which is associated with the operating system of the computer. Such data may be stored on the computer's clipboard in a variety of different formats, which are useful to different types of applications.

The method of the present invention includes recognizing that a change has been made to the clipboard of a particular, first computer of a predefined network and notifying the other computers that are part of the predefined network that the clipboard data on the first computer has been changed. The other computers that are part of the predefined network may also be notified about information on the formats in which the data is stored on the updated clipboard of the first computer.

When a “paste” command is issued by an application that is being run on another, second computer of the predefined network (i.e., not the computer with the updated clipboard), data is requested from the clipboard of the first computer, on which the data was originally stored, in a format that is compatible with the application in which the request was made. The data of that particular format is then accessed and inserted, as desired, into the application that is being executed on the second computer. The data is not transferred from the clipboard of the first computer to the application running on the second computer until a “paste” command is issued on the second computer.

Multiple computers may perform such a “remote paste” when “copy” and “paste” commands are issued on a second computer of the predefined network.

A method that incorporates teachings of the present invention may be used to transfer data in any of a variety of formats, including application-specific, or “registered” or “private,” formats, from the clipboard of the first computer to an application which is running on a second computer, provided the running application recognizes at least one of the formats of data stored on the clipboard of the first computer.

The method and program of the present invention may provide a “transparent” mechanism for sharing clipboard data between any number of networked computers without requiring a user to perform any extra actions other than issuing a “copy” command on a first computer and a “paste” command on one or more other, second computers that are networked or otherwise in communication with the first computer. No dialogs or selection, or “clicking,” of extra icons, or “buttons,” are required to navigate through the network in order to accomplish a remote paste in accordance with teachings of the present invention.

The method and program may be configured to share data on a multiple-item clipboard. If so, the messages between computers provide not only formats of the data, but also an identifier for the data, as is well known for use with clipboards that are configured to temporarily store multiple packets of data.

Of course, a program according to the present invention comprises source code, object code, or machine language which, when executed by a processor of a first computer, provides the processor with instructions on notifying other, second computers of the predefined network that new data is available on the clipboard of the first computer or, when executed by a processor of a second computer, causes the processor of the second computer to request the clipboard data from the first computer when a “paste” or a “remote paste” command is input or otherwise issued by an application running on the second computer.

A computer network that incorporates teachings of the present invention includes a plurality of computers that are in communication with one another, on each of which a program according to the present invention is running, and which have been identified as “members” of a defined virtual clipboard group. The computers that make up the virtual clipboard group can be configured as members of the virtual clipboard group once, as known in the art, such as when the program is being setup thereon or whenever a user desires (e.g., at “copy” and “paste” time, prior thereto, etc.).

Other features and advantages of the present invention will become apparent to those of skill in the art through a consideration of the ensuing description, the accompanying drawings, and the appended claims.

### BRIEF DESCRIPTION OF THE DRAWINGS

In the drawings, which illustrate exemplary embodiments of various features of the present invention:

FIG. 1 is a flowchart depicting an initiation process of the present invention, which occurs as a first computer effecting a method (e.g., by way of a program that incorporates teachings of the present invention) is turned on or as the method is otherwise executed, as well as a “waiting” process, wherein the computer awaits a notification, or an indication, from the operating system (OS) thereof that the data on that computer's clipboard has been changed;

FIG. 2 is a flowchart which shows an exemplary process by which a second computer of a virtual clipboard group awaits and receives messages from other computers of the virtual clipboard group of changes that have been made to the clipboards of one or more of the other, networked computers, as well as the processes that are effected when the second computer receives an indication that the data on a clipboard of another, first computer of the virtual clipboard group has been changed, and when the second computer requests data from the clipboard of the first computer;

FIG. 3 is a flowchart that illustrates an example of a process that occurs when a program of the present invention receives an indication from the operating system of the computer on which the program is running that that computer's clipboard data has been updated or changed; and

FIG. 4 is a flowchart that depicts an exemplary process that occurs when a “paste” or “remote paste” command is issued by a second computer of the virtual clipboard group; and

FIG. 5 is a schematic representation of a networked group of computers, or virtual clipboard group, by which methods that incorporate teachings of the present invention may be effected.

### DETAILED DESCRIPTION

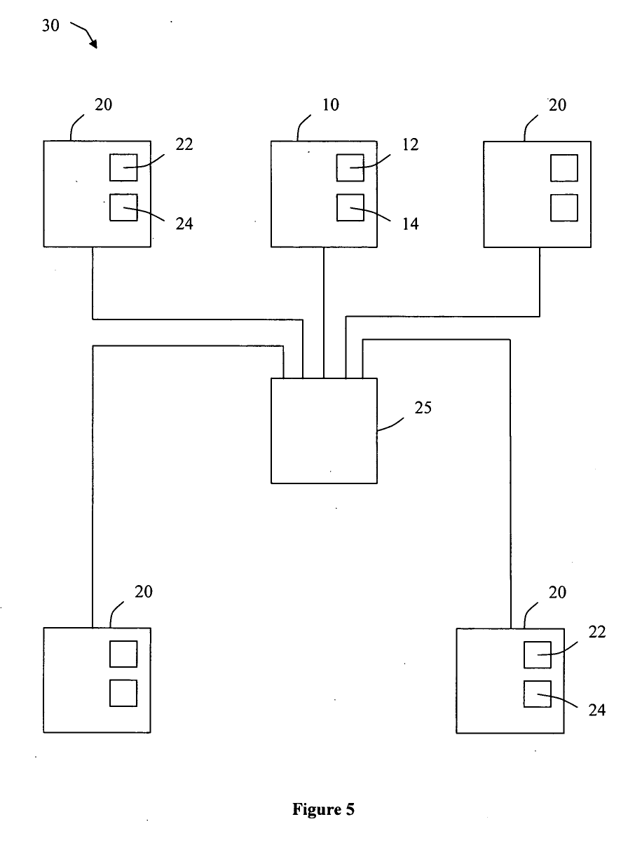

A networked group 30 of computers 10, 20, or “virtual clipboard group,” is schematically depicted in FIG. 5. As illustrated, each computer 10, 20 includes a processing element 12, 22, such as a computer process of a known type (e.g., an Intel® Pentium IV® processor), and memory 14, 24 (e.g., random-access memory (RAM), read-only memory (ROM), one or more disk drives, etc.) associated with processing element 12, 22. Additionally, each computer 10, 20 includes at least one communication element (e.g., a modem, a wireless communication device, a LAN connection, etc.) (not shown) in communication with processing element 12, 22 thereof. Processing elements 12, 22 of computers 10, 20 may communicate with one another by any suitable technique known in the art, such as through a server 25, through a router, in a daisy chain configuration, or otherwise.

For the sake of simplicity, computer 10 is also referred to herein as “first computer 10” and computers 20 are also referred to herein as “second computers 20.” While these designations are used herein to indicate the source and recipient of clipboard data, it should be understood that the sharing of data on a clipboard associated with a processing element 12, 22 of any of computers 10, 20 with the operating systems of the processing element 12, 22 of any other computer 10, 20 of networked group 30 is within the scope of the present invention.

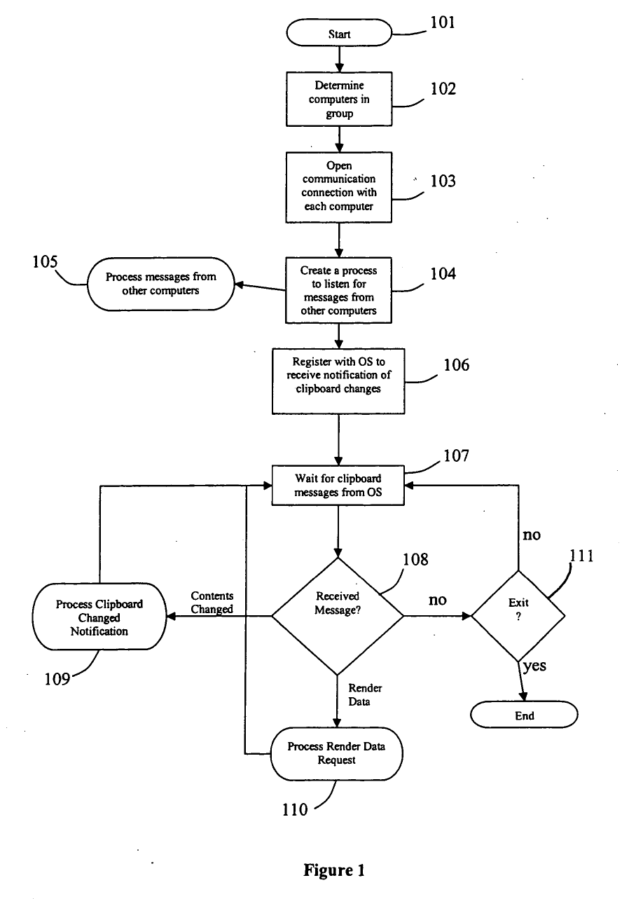

An example of a clipboard data-sharing method of the present invention is hereinafter described with reference to FIG. 5, as well as to the flowcharts of FIGS. 1 through 4. As will become apparent from consideration of the ensuing description, the method of the present invention may be effected by a program, which may be in the form of software, firmware, or even programmed hardware. A program that incorporates teachings of the present invention is configured to operate a processing element 12, 22 of a computer in conjunction with the software, or “operating system” (e.g., Windows® XP, etc.) that orchestrates operation of that processing element 12, 22.

The flow chart of FIG. 1 provides an overall view of process flow of an exemplary method that incorporates teachings of the present invention. At reference character 101, a method according to the present invention is initiated, such as by initiating a computer program that operates in accordance with the method. Initiation of a computer program may be effected by any suitable means, such as by selecting and loading, or starting, an executable program file by which the method is embodied, by automatically initiating such an executable program file when a processing element 12, 22 of a computer 10, 20 on which the program is to be run is activated, or turned on, or otherwise, as known in the art.

When a program that effects the method of the present invention has been initiated and begins running, it causes processing element 12 of first computer 10 to identify, in a manner known in the art, each other computer 20 in networked group 30 that is in communication with processing element 12 of computer 10 and that is also running a program that effects at least a portion of the inventive method, as shown at reference character 102. Next, at reference character 103, communication may be established between processing element 10 of first computer 10 and processing element 12 of each second computer 20 of networked group 30 on which the program is running (e.g., by TCP connection). Additionally, it may be necessary to validate whether or not each computer 10, 20 attempting to communicate with other computers of networked group 30 has been configured for use in networked group 30.

When processing elements 12, 22 of two or more computers 10, 20 of networked group 30 have been activated, or turned on, they generate signals that are detected by one another. Such signals, which may be transmitted by processing elements 12, 22 or other components of computers 10, 20 are received, at reference character 104, and processed by a processing element 12, 22 of another computer 10, 20, at reference character 105, as known in the art. In this manner, by means that are well-known in the art, network links between processing elements 12, 22 of computers 10, 20 and, thus, communication therebetween, may be established.

With communication between processing elements 12, 22 of computers 10, 20 of networked group 30 established, as shown at reference character 106, processing element 12, 22 of each computer 10, 20 of networked group 30 identifies all of the other computers 10, 20 of networked group 30 on which a program that effects all or part of a method of the present invention is running. Such a program causes a processing element 12, 22 of a computer 10, 20 on which the program is running to “register with” the operating system of each processing element 12, 22 of each other computer 10, 20 of networked group 30 on which a program that incorporates teachings of the present invention is running, as known in the art. In this manner, processing elements 12, 22 of all of the computers 10, 20 of networked group 30 on which such a program is running will readily recognize one another. Moreover, by registering with the operating system, a program of the present invention requests to be notified whenever the contents of a clipboard associated with at least one processing element 12, 22 of at least one computer 10, 20 of networked group 30 is updated or changed. When the operating system is a Windows® operating system, this notification may be in the form of a message sent to the main application message queue of the operating system in a manner known in the art. Of course, operating systems may notify a program of the present invention when data on a clipboard associated with a processing element 12, 22 of a computer 10, 20 of networked group 30 has been updated or changed by other mechanisms, such as by callback functions or otherwise, as known in the art.

Processing element 12, 22 of each computer 10, 20 then “waits” and “listens” for clipboard-related signals, or “messages,” from processing elements 12, 22 of other computers 10, 20, at reference characters 107 and 108. For example, a program that effects a method of the present invention instructs a processing element 22 of each second computer 20 to await a signal from a processing element 12 of first computer 10 that the data on a clipboard associated with processing element 12 has been changed, as shown at reference character 109. Likewise, a program that effects a method of the present invention may instruct a processing element 12 of a first computer 10 to await a signal from a processing element 22 of a second computer 20 that a request has been made to “copy” data on a clipboard that is associated with processing element 12 of first computer 10, as indicated by reference character 110. These messages are then processed, as known in the art, to achieve the desired result.

In the event that no such messages are received by processing element 12, 22 over a given period of time, a computer 10, 20 user may be provided with an option to exit the program, at reference character 11. If the user decides to exit the program, the program is terminated, as known in the art. Otherwise, process flows back to reference character 107, where processing element 12, 22 continues “waiting” and “listening” for clipboard-related signals from a processing element 12, 22 of another computer 10, 20 of networked group 30.

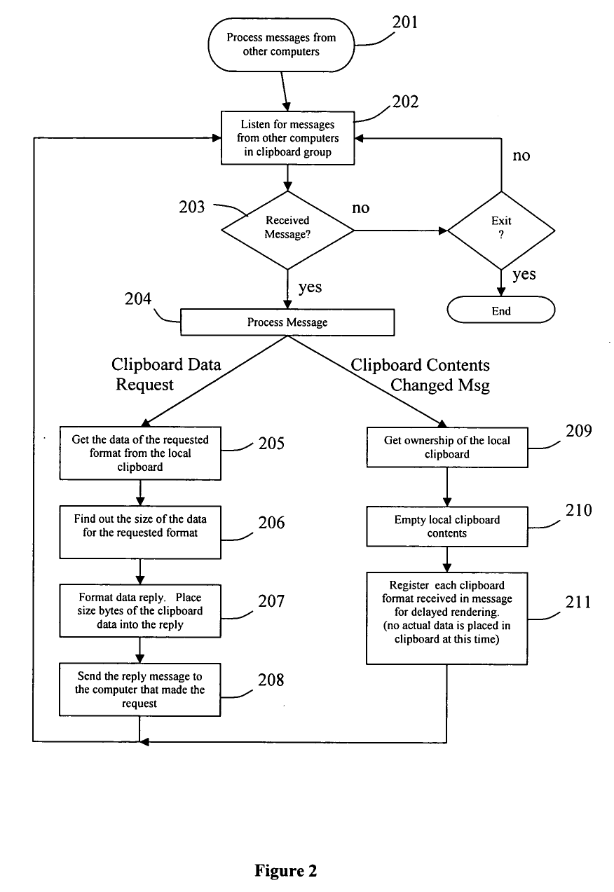

Turning now to FIG. 2, process flow of the method acts that are depicted at reference characters 107 to 111 of FIG. 1 is explained in further detail. At reference characters 202 and 203, which are equivalent to reference characters 107 and 108 of FIG. 1, a processing element 12, 22 of each computer 10, 20 of networked group 30 “waits” and “listens” for clipboard-related signals, or “messages,” from processing elements 12, 22 of other computers 10, 20 of networked group 30. At reference character 204, any received messages are processed.

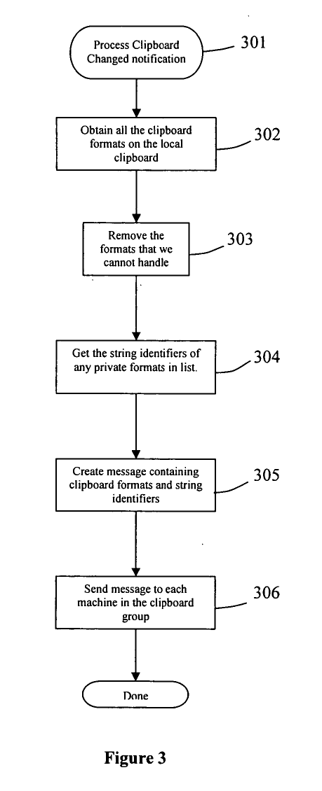

The process flow that is effected by a processing element 12 of a first computer 10 operating under control of a program that incorporates teachings of the present invention when data on a clipboard that is associated with processing element 12 is updated or changed is shown in FIG. 3. At reference character 301, processing element 12 determines that the clipboard data has been updated or changed. At reference character 302, processing element 12 obtains information on all of the available formats of the data stored on the associated, local clipboard.

When data is temporarily stored, or placed, on a clipboard, one or more accompanying format identifiers may also be temporarily stored on the clipboard. The format or formats that correspond to a packet of data that is temporarily stored on the clipboard are determined by the application, or program, from which the data is copied. For example, some applications are configured to share data with as many other, different types of applications and, thus, in a variety of different formats.

Exemplary data formats include standard formats (e.g., plain text, various types of stylized text, etc.) or registered, or private, formats that are only understood by an application or family of applications. Plain text formats may be used by simple text editors, as well as more complex applications. Registered data formats are used by applications to place complex data onto a clipboard that may only be used by that application or a corresponding family of applications. The application registers these formats with the operating system that oversees the functions of the processing element on which the application is being run and receives a unique format identifier for use while the application is running. As an example of a registered format, a word processing application might share text data using a registered format that contains data corresponding to font size, font style, or other formatting information.

For some data formats, the data that is temporarily stored on a clipboard refers to other data that might be stored elsewhere, such as on a hard drive, CD-ROM, etc. For example, the format for files or directories that are “copied” to the clipboard may be handled in this manner. Rather than placing the actual file or directory data on the clipboard, the path or paths to the files or directories are temporarily stored on the clipboard. A program the effects one or more aspects of a method of the present invention is configured to recognize standard formats, including formats that comprise paths to files that are located on a local disk.

Information regarding data formats that are not useful to a program running on processing element 12 of first computer 10 or processing element 22 of second computer 20, or that cannot be handled by processing element 12 or 22 are disregarded, as shown at reference character 303. These may include formats that are not self-contained (i.e., do not refer to known data on the local disk or to an object “owned by” the operating system) and not published may be ignored.

The program may, at reference character 304, cause processing element 12 to obtain (e.g., from memory 14 associated with processing element 12), from the application in which the “copy” command is issued, one or more string identifiers, or string names, of types known in the art, for information included in the signal regarding any registered, or private, formats that correspond to the data on the updated clipboard.

The identifier for a registered clipboard format may be randomly assigned by the operating system when the application that created the format is loaded. An application that uses registered clipboard formats registers the format by presenting the operating system with a string name. The operating system then generates a format identifier that is within a known range of integers. As such a format identifier may be randomly generated by the operating system, it may not be the same every time a particular application is run.

Data formats may be placed on the clipboard in order of degree of detail. They may then be supplied by the operating system in the same order. For example, the format that has the greatest degree of detail is placed in a first “position,” while the format that has the least detail is placed in a last “position” on the clipboard.

Next, at reference character 305, the program causes processing element to generate a message, in the form of an electronic signal, which includes data of the formats in which data on the associated clipboard is available, as well as data on any string identifiers. As the format identifier for a registered format may be randomly generated by an operating system, it may not be the same every time a particular application is run. For this reason, a program according to the present invention may cause processing element 12 of first computer 10 to transmit the string name associated with a particular registered format to processing elements 22 of second computer 20 when data in that registered format is temporarily stored on a clipboard associated with processing element 12.

The order in which the data is presented in such a message may be the same as the order in which the data formats have been temporarily stored on the clipboard. The message is then transmitted to and processed by, as known in the art, processing elements 22 of all of the second computers 20 of networked group 30 on which programs that incorporate teachings of the present invention are being executed, as shown at reference character 306.

With returned reference to FIG. 2, if, at reference character 204, a processing element 22 of a second computer 20 receives a signal that comprises an indication that the data on a clipboard running on or otherwise associated with processing element 12 of a first computer 10 of networked group 30 has been updated or changed, process flows to reference characters 209-211.

At reference character 209 of FIG. 2, the program causes processing element 22 of second computer 20 (i.e., a computer which is remote from the computer (e.g., first computer 10) on which the clipboard data has been updated or changed) to assume control over its associated clipboard and, thus, to relinquish control by processing element 12, 22 of any other computer 10, 20 of networked group 30 over that clipboard. In addition, at reference character 210, all of the data on the clipboard associated with processing element 22 of second computer 20 may removed therefrom, as known in the art. In this manner, issuance of a “paste” command to processing element 22 may result in pasting of data from the clipboard associated with processing element 12 of first computer 10, rather than an instruction to “paste” data from the clipboard of the second computer 22 at which the “paste” command has been made.

If the data format is a registered format, the string name of the format may be used to create or obtain the corresponding format identifier from processing element 12 of computer 10. For example, processing element 22 may use the string name, rather than the randomly generated format identifier (which may not be available to processing elements 22) when requesting data in a registered format from the clipboard associated with processing element 12. This process facilitates identification by processing element 12 of the appropriate (registered) format for clipboard data that is to be transmitted to processing element 22. Additionally, when a “paste” command is issued, the string name may be presented to the operating system that oversees the function of processing element 22 so that the operating system may generate a format identifier to be associated with data of the registered format that is placed on the local clipboard (i.e., the clipboard associated with processing element 22).

“Delayed rendering,” meaning the actual data for each format is not given to the clipboard at the time the “copy” command is issued; rather, it may be requested by the operating system from a local disk, may take the place of temporarily storing registered formats on the clipboard. Each data format, as indicated by a signal that data on the clipboard associated with processing element 12 of first computer 10 has been updated or changed, may then be registered for delayed rendering of the clipboard or format data. If delayed rendering is not supported by the operating system, the application in which the “copy” command is issued, or a program incorporating teachings of the present invention, the data for each format may be requested from the local disk and placed on the clipboard.

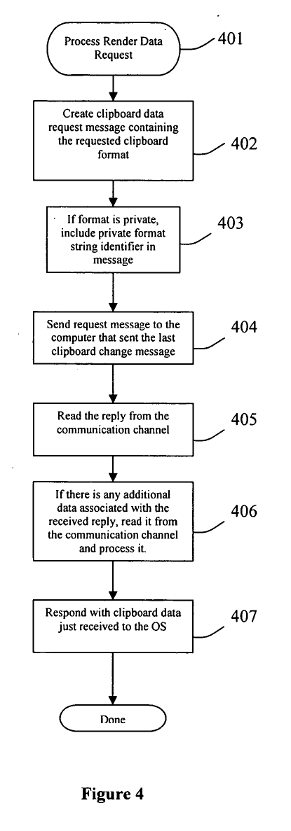

At this point, a program according to the present invention does not have “ownership” of the data to be pasted. FIG. 4 illustrates an exemplary process flow that may be effected, under control of a program according to the present invention, by a processing element 22 of a second computer 20 at which data from a clipboard running on or associated with a processing element 12 of another, first computer 10 is requested.

At reference character 401, a data request (e.g., a “paste” or “remote paste” command) is processed by processing element 22 of second computer 20. Next, at reference character 402, the program causes processing element 22 to generate a message, in the form of a data request, which includes information on the desired format or formats of the data to be requested. Thus, data in a single format or multiple formats may be requested. If the desired data format is a registered, or private, format, the string name that corresponds to the identifier for the registered format may be included in the message, as shown at reference character 403. The message is then sent, in the form of electronic signals, to processing element 12 of first computer 10 (i.e., the computer on which the clipboard data was most recently updated or changed), at reference character 404.

Returning reference to FIG. 2, if, at reference character 204, a processing element 12 of a first computer 10 receives a message that comprises a request for data from a clipboard running on or otherwise associated with processing element 12, process flows to reference characters 205-208. At reference character 205, the program causes processing element 12 to determine a data format that corresponds to the data request. At reference character 206, processing element 12 determines the size (in bytes) of the data request, in the requested format. At reference character 207, the program causes the processing element 12 to format a reply to the data request, which includes placement of an indicator of the size (in bytes) of the data in the requested format. Thereafter, at reference character 208, processing element 12 of first computer 10 transmits, or sends, a reply message to processing element 22 of second computer 20 (i.e., the computer by which the clipboard data was requested).

Referring again to FIG. 4, the reply that was transmitted at reference character 208 of FIG. 2 is received, at reference character 405, by processing element 22 of the second computer 20 from which the data request was made. As shown at reference character 406, any additional data that accompanied the requested clipboard data may also be processed by processing element 22. Processing element 22 then provides the requested data to its operating system, which may temporarily store the requested data to a clipboard associated therewith and/or “paste” the data, as instructed by a program running on processing element 22, as illustrated at reference character 407.

All computers 10, 20 of networked group 30 may effectively receive messages regarding an update or change in the data temporarily stored on a clipboard associated with a processing element 12 of first computer 10 at the same time. When new data is placed on a clipboard associated with processing element 12, all self-contained clipboard data formats may be immediately communicated to processing elements 12, 22 of all other computers 10, 20 in networked group 30. Even though each clipboard data format is placed on the clipboard associated with processing element 12 of first computer 10, the actual data corresponding to each format may not be placed on the clipboards that are associated with processing elements 22 of second computers 20 at that time. Rather, the operating systems that oversee operation of processing elements 22 may wait to request formatted data for their associated clipboards when a “paste” command is issued.

### EXAMPLE

As an example of a manner of operation of a method and program of the present invention, suppose that a single user is operating three separate networked computers, A, B and C, as known in the art. As the user proceeds, he wants to “copy” or “cut” data in some format from computer A for possible use with computers B and/or C. The operating system on computer A automatically applies the data to the clipboard of that computer in one or more formats, so it will more likely to be useful with a variety of applications.

At the same time, the program of the present invention causes computer A to send a message to computers B and C that the data has been “copied” onto the clipboard. Computers B and C accept the information about the formats of the data but do not actually download the data until requested. This saves memory for computers B and C and reduces unnecessary network “traffic,” while making the data “virtually” appear to be on their clipboards.

Once the user needs the data on computer B and/or computer C, the user simply pastes the data, which automatically downloads the data from computer A. So it is there for all intents, which is why it is referred to as a “transparent” system.

There is no need for a program that incorporates teachings of the present invention to parse, “understand,” or otherwise process requested, “pasted” data. In networked groups 30 that include computers 10, 20 with processing elements 12, 22 that function under control of Windows® operating systems, the data that is temporarily stored on a clipboard data is stored as a “pointer” to global memory. Such operating systems provide a function call that indicates the amount of global memory consumed by the data on the clipboard associated with processing element 12 of first computer 10. That amount of global member is the same amount that is subsequently transmitted to processing element 22 of a second computer 20.

The program of the present invention may, however, understand data formats that comprise paths to files or directories which have not been directly stored on the clipboard, but are stored on a local disk. In this regard, a program according to the present invention is configured to copy all directories, or subdirectories, or files that are identified by such path data to a temporary location on remote machine (e.g., second computer 20), as well as send the file paths that have been stored on the clipboard. By way of nonlimiting example, when a “paste” command for such data is made, a program that incorporates teachings of the present invention may create a temporary directory and modify the “pasted” paths to point to the temporary directory before placing the data on the clipboard of the requesting computer (e.g., the clipboard associated with processing element 22 of second computer 20).

When the data on a clipboard is updated or changed, new clipboard data formats may be sent to each computer in a networked group, causing the prior clipboard data on these computers to be lost. In order to avoid permanent loss of such data, a program of the present invention may be configured to store all previous clipboard data each time the clipboard data is updated or changed. A user interface of the program may be configured to allow a user to restore prior local clipboard data to a local clipboard or to the clipboard of each computer in the networked group. For example: the user copies a section of text on Computer A. Computers B and C lose their clipboard contents because they receive new clipboard contents from A. Then the user copies a file on Computer B. The clipboards on A and C lose the text that A originally placed on the clipboard. The user can go to Computer A and restore the last local data to the clipboard. It can be restored to only the clipboard on Computer A or to all computers in the clipboard group.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

1. A method for sharing clipboard data between different computers of a group, comprising:
commanding a first computer of the group to copy or cut selected data to a clipboard of the first computer;
causing the first computer to send a message to at least a second computer of the group that the data on the clipboard has been updated;
providing the second computer with access to the clipboard; and
commanding an application operating on the second computer to paste the selected data.

2. The method of claim 1, wherein the commanding the first computer consists of causing the first computer to copy or cut the selected data.

3. The method of claim 2, wherein commanding the application operating on the second computer consists of causing the second computer to paste the selected data.

4. The method of claim 1, wherein providing the second computer with access to the clipboard comprises providing the second computer with information of each format in which the selected data is stored on the clipboard.

5. The method of claim 4, wherein commanding the application comprises obtaining a single, application-compatible format of the selected data.

6. The method of claim 1, wherein providing does not include copying the selected data to a clipboard of the second computer.

7. A method for transmitting data in a registered format from one computer to another computer, comprising:
providing an operating system of a first computer running an application in which a copy command is issued with a string name;
generating a message on the first computer that clipboard data on the first computer has been updated and including the string name that corresponds to the registered format;
transmitting the message to at least one second computer;
issuing a paste command on the at least one second computer, comprising generating a request including the string name and transmitting the request to the first computer; and
in response to the request from the at least one second computer, transmitting requested data from the clipboard of the first computer to the clipboard of the at least one second computer.

8. The method of claim 7, wherein operating system on the first computer randomly generates a numeric format identifier following providing the operating system with the string name.

9. The method of claim 7, wherein, following transmitting the message, the at least one second computer presents the string name to an operating system thereon and the operating system generates a numeric format identifier to be associated with the requested data on the clipboard of the at least one second computer.

10. A computer network, comprising:
a first computer including at least one first processing element operating under at least partial control of a program that:
causes the at least one first processing element to recognize when an operating system associated therewith has caused data to be applied to a clipboard; and
causes the at least one first processing element to send a message to at least one second computer of the computer network when data on the clipboard of the first computer is changed; and
the at least one second computer including at least one second processing element operating under at least partial control of a program that:
causes the at least one second processing element to receive the message; and
upon receiving a command from an application running on the at least one second computer, retrieves at least a portion of the data from the clipboard of the first computer and imports at least the portion of the data into the application.

11. The computer network of claim 10, wherein the program causes the at least one first processing element to recognize when a copy or cut command has been issued by an application running on the first computer.

12. The computer network of claim 11, wherein the command from the application running on the second computer comprises a paste command.

13. The computer network of claim 10, wherein the message sent by the at least one first processing element includes information about a plurality of formats of the data available on the clipboard.

14. The computer network of claim 13, wherein the program that at least partially controls the at least one second processing element is configured to select a format of at least the portion of the data from the plurality of formats to be imported into the application.

15. A computer network, comprising:
a first computer including at least one first processing element programmed for:
copying or cutting selected data to a clipboard; and
sending a message to at least one second computer of the computer network when data on the clipboard of the first computer is changed; and
the at least one second computer including at least one second processing element operating under at least partial control of a program for:
causing the at least one second processing element to receive the message; and
upon receiving a command from an application running on the at least one second computer, retrieving at least a portion of the data from the clipboard of the first computer and importing at least the portion of the data into the application.
